(19) United States
(12) Patent Application Publication
(10) Pub. No.: US 2019/0270095 A1
(43) Pub. Date: Sep. 5, 2019

(54) PULSE FIRING PATTERN FOR A TRANSFORMER OF AN ELECTROSTATIC PRECIPITATOR AND ELECTROSTATIC PRECIPITATOR

(71) Applicant: General Electric Technology GmbH, Baden (CH)

(72) Inventors: Carl Marcus Williamsson, Ljungby (SE); Nanda Kishore Dash, Bhubaneswar Odisha (IN); Anders Nils Gustav Karlsson, Vaxjo (SE); Inger Elisabeth Önnerby Pettersson, Vaxjo (SE)

(73) Assignee: General Electric Technology GmbH, Baden (CH)

(21) Appl. No.: 16/418,275

(22) Filed: May 21, 2019

Related U.S. Application Data
(63) Continuation of application No. 15/184,205, filed on Jun. 16, 2016.

(30) Foreign Application Priority Data
Jun. 29, 2015 (IN) 1922/DEL/2015

(51) Int. Cl. B03C 3/68; B03C 3/41; B03C 3/45

(52) U.S. Cl. CPC B03C 3/68; B03C 3/45; B03C 3/41

(57) ABSTRACT

The pulse firing pattern for a transformer of an electrostatic precipitator comprises first elements indicative of a pulse to be fired and second elements indicative of a pulse to not be fired. The pulse firing pattern further comprises couples of adjacent second elements and at least two first elements.

### CROSS-REFERENCE TO RELATED APPLICATIONS

This Application is a continuation of U.S. patent application Ser. No. 15/184,205 filed Jun. 16, 2016, which claims priority to Indian Patent Application No. 1922/DEL/2015 filed Jun. 29, 2015, the contents of the foregoing being hereby incorporated in their entirety.

### TECHNICAL FIELD

The present invention relates to a pulse firing pattern for a transformer of an electrostatic precipitator and electrostatic precipitator.

For example, the electrostatic precipitator is of the type used in a power plant or in an industrial application. Other applications with smaller electrostatic precipitators are anyhow possible.

### BACKGROUND

Electrostatic precipitators are known to comprise a filter connected to a transformer in turn connected to a rectifier. Typically the transformer and the rectifier are embedded in one single unit. The filter is connected to a power supply, such as to the electric grid; the rectifier is in turn connected to collecting electrodes and discharge electrodes.

During operation the filter receives the electric power from the electric grid (e.g. this electric power can have sinusoidal voltage and current course) and skips some of the half waves of the electric power (e.g. voltage or current) according to a pulse firing pattern, generating a pulsed power that is supplied to the transformer.

The pulse firing pattern is a sequence of first elements indicative of a pulse to be fired and second elements indicative of a pulse to be not fired. The pulse firing pattern is defined as a pulse period or pulse firing pattern length having one first element and an even number of second elements; the pulse period thus has an odd number of elements.

If the transformer is supplied with a pulsed power having two or more successive pulses of the same polarity (i.e. positive or negative), this would cause a risk of saturation of the transformer. For this reason the pulse firing patterns traditionally used have one first element and an even number of second elements.

In addition, traditionally supply of pulsed power was only done to adapt the power sent to the collecting electrodes and discharge electrodes to the properties of the flue gas (e.g. in terms of resistivity), whereas energy management (to regulate the power sent to the collecting electrodes and discharge electrodes) was done by regulating the amplitude of the pulses.

Nevertheless, since when using pulse firing patterns only some but not all power from the electric grid is supplied to the collecting electrodes and discharge electrodes, the pulse firing patterns limit the power supplied to the collecting electrodes and discharge electrodes.

FIGS. 1, 2a, 2b, 3a, 3b show the voltage or current supplied to the transformer.

FIG. 1 shows the case when no pulse firing pattern is applied and all power from the electric grid is supplied to the transformer. In particular, reference 1 identifies the voltage or current supplied from the grid to the filter and reference 2 the voltage or current supplied from the filter to the transformer. In this case 100% of the power from the electric grid is supplied to the transformer and thus to the collecting electrodes and discharge electrodes.

FIG. 2a shows the case when the pulse firing pattern of FIG. 2b is applied at the filter and only ⅓ of the power from the electric grid is forwarded to the transformer, while ⅔ of the power from the electric grid is blocked at the filter and not supplied to the transformer. Also in this case, reference 1 identifies the voltage or current supplied from the grid to the filter and reference 2 the voltage or current supplied from the filter to the transformer. The curly brackets 3 identify the pulse period or pulse firing pattern length. In this case 33% of the power from the electric grid is supplied to the transformer and thus to the collecting electrodes and discharge electrodes.

FIG. 3a shows the case when the pulse firing pattern of FIG. 3b is applied and ⅕ of the power from the electric grid is forwarded to the transformer and ⅘ of the power from the electric grid is blocked at the filter and not supplied to the transformer. In this case as well, reference 1 identifies the voltage or current supplied from the grid to the filter, reference 2 the voltage or current supplied from the filter to the transformer and the curly brackets 3 identify the pulse period or pulse firing pattern length. In this case 20% of the power from the electric grid is supplied to the transformer and thus to the collecting electrodes and discharge electrodes.

It is thus apparent that the step between use of no pulse firing pattern (FIG. 1) and use of the pulse firing pattern that allows supply of the largest power to the collecting electrodes and discharge electrodes (FIG. 2a, 2b) corresponds to 67% of the power supplied from the electric grid.

This large power step could not allow optimal operation, because only in case the features of the gas being treated allow supply of the collecting electrodes and discharge electrodes with only 33% of the power supplied from the grid it is possible the use of pulse firing pattern; if use of 33% of the power from the grid is not possible in view of the features of the gas being treated, it is needed operation without pulse firing pattern. In other words, if the features of the gas could require use of a pulse firing pattern corresponding to e.g. 50% of the power from the electric grid, it is not possible operation with the pulse firing pattern, because use of the pulse firing pattern would allow supplying the collecting electrodes and discharge electrodes with only 33% of the power from the electric grid. It would thus be needed operation without pulse firing pattern.

In addition, power regulation made via amplitude reduction (of voltage and/or current), as traditionally done, affects the corona discharge from the discharge electrodes and thus negatively affects dust charging (that occurs via corona) and therefore dust collection at the collecting electrodes.

### SUMMARY

An aspect of the invention includes providing a pulse firing pattern and an electrostatic precipitator that allow an improvement of the regulation of the power supplied to the collecting electrodes and discharge electrodes. Advantageously according to the invention fine regulation can be achieved.

These and further aspects are attained by providing a pulse firing pattern and an electrostatic precipitator in accordance with the accompanying claims.

Advantageously, amplitude regulation (voltage and/or current) is not needed for regulation, such that amplitude regulation does not affect or can be made to affect to a limited extent the corona discharge.

### BRIEF DESCRIPTION OF THE DRAWINGS

Further characteristics and advantages will be more apparent from the description of a preferred but non-exclusive embodiment of the pulse firing pattern and electrostatic precipitator, illustrated by way of non-limiting example in the accompanying drawings, in which:

FIG. 1 shows the voltage or current entering and moving out of a filter when no pulse firing pattern is used (prior art);

FIG. 2a shows the voltage or current entering and moving out of a filter when the pulse firing pattern shown in FIG. 2b is used (prior art);

FIG. 2b shows a pulse firing pattern (prior art);

FIG. 3a shows the voltage or current entering and moving out of a filter when the pulse firing pattern shown in FIG. 3b is used (prior art);

FIG. 3b shows a pulse firing pattern (prior art);

FIG. 4 shows an electrostatic precipitator;

FIGS. 5a through 5e show different examples of pulse firing patterns;

FIG. 6 shows the voltage or current at different positions of the electrostatic precipitator.

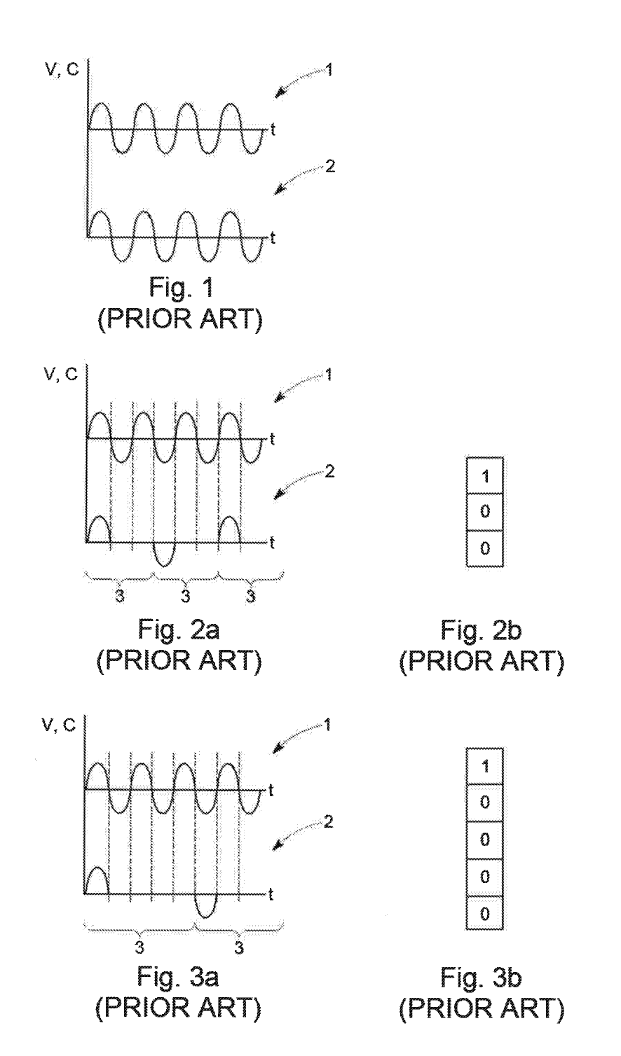

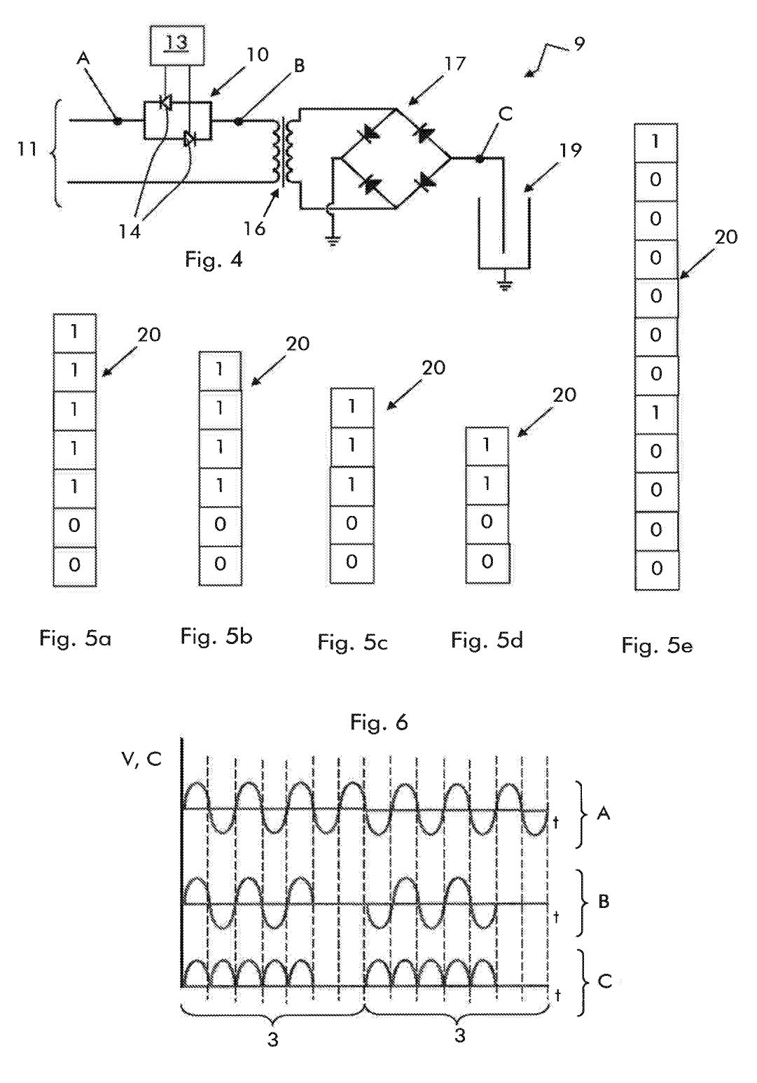

### DETAILED DESCRIPTION

In the following the electrostatic precipitator is described first.

The electrostatic precipitator 9 comprises a filter 10 connected to a power input 11; the filter 10 is arranged for filtering an input power from the power input 11, generating a pulsed power according to a pulse firing pattern.

A control unit 13 is connected to the filter 10 in order to drive it and implement the pulsed firing pattern. For example, the filter can comprise transistors or other types of electronic switches 14.

A transformer 16 is connected to the filter 10; the transformer 16 is arranged for transforming the pulsed power from the filter 10 into a transformed pulsed power.

A rectifier 17 is connected to the transformer 16; the rectifier 17 is arranged for rectifying the transformed pulsed power generating a rectified pulsed power.

Collecting electrodes and discharge electrodes 19 are connected to the rectifier 17 for receiving the rectified pulsed power. The collecting electrodes and discharge electrodes 19 are immersed in a path where the flue gas to be cleaned passes through.

The control unit 13 implements the pulse firing pattern, i.e. drives the electronic switches 14 to pass to an electric conductive state or electric non-conductive state according to the pulsed firing pattern.

FIGS. 5a through 5e show some possible pulse firing patterns 20, namely:

FIG. 5a shows a pulse firing pattern 20 that allows to transfer 71% of the power from the power input 11 to the transformer 16 and thus to the collecting electrodes and discharge electrodes 19;

FIG. 5b shows a pulse firing pattern that allows to transfer 67% of the power from the power input 11 to the transformer 16 and thus to the collecting electrodes and discharge electrodes 19;

FIG. 5c shows a pulse firing pattern that allows to transfer 60% of the power from the power input 11 to the transformer 16 and thus to the collecting electrodes and discharge electrodes 19;

FIG. 5d shows a pulse firing pattern that allows to transfer 50% of the power from the power input 11 to the transformer 16 and thus to the collecting electrodes and discharge electrodes 19;

FIG. 5e shows a pulse firing pattern that allows to transfer 17% of the power from the power input 11 to the transformer 16 and thus to the collecting electrodes and discharge electrodes 19.

Even if only few examples are given above, it is clear that the pulse firing pattern 20 according to the invention can allow to transfer any power from the power input 11 to the transformer 16 and thus to the collecting electrodes and discharge electrodes 19. The pulse firing pattern 20 comprises:

first elements indicative of a pulse to be fired; these elements are indicated as “1” in the attached figures;

second elements indicative of a pulse to not be fired, these elements are indicated as “0” in the attached figures.

For example the pulse firing pattern can have less than 20, or less than 1000 or at least 1000 or at least 10000 elements between the first elements and the second elements.

The pulse firing pattern 20 comprises couples of adjacent second elements “0” (i.e. an even number of adjacent elements “0”) and at least two first elements “1”.

In the following an example of operation using a pulse firing pattern of FIG. 5a is described. FIG. 6 shows the voltage or power at different positions A, B, C of the electrostatic precipitator 9.

The power input 11 (e.g. electric grid) supplies electric power whose voltage or current has e.g. sinusoidal course (FIG. 6, position A). At the filter 10 only the half waves in correspondence of a “1” of the pulsed firing pattern 20 are allowed to pass through, whereas half waves in correspondence of “0” of the pulse firing pattern 20 are blocked.

FIG. 6, position B shows the voltage or current downstream of the filter 10 and upstream of the transformer 16.

After the transformer, the electric power is rectified at the rectifier 17; FIG. 6, position C shows the voltage or current downstream of the rectifier 17.

Implementation of the pulse firing pattern 20 in an electrostatic precipitator 9 allows supply of any power to the collecting electrodes and discharge electrodes 19, but the transformer 16 is not supplied with successive pulses of the same sign such that no saturation of the transformer occurs.

One way of defining a pulse firing pattern allowing to transfer to the collecting electrodes and discharge electrodes a desired or required power can comprise:

a) defining a target parameter indicative of the power to be supplied to the collecting electrodes and discharge electrodes 19;

b) calculating a first parameter indicative of the power supplied to the collecting electrodes and discharge electrodes 19 using the pulse firing pattern being calculated, in case one additional pulse is fired,

c) calculating a second parameter indicative of the power supplied to the collecting electrodes and discharge electrodes 19 using the pulse firing pattern being calculated, in case two additional successive pulses are not fired,

d) selecting pattern elements between one first element or two second elements on the basis of the first parameter or second parameter,

e) repeating steps b), c), d), e).

Selecting pattern elements can be done:

on the basis of which parameter between the first parameter or second parameter falls closer to the target parameter or, in case this is not possible, because e.g. none of the first parameter or second parameter falls closer to the target parameter (e.g. the first parameter and second parameter have the same distance from the target parameter)

a given pattern element can be selected; e.g. in this case the pattern element “1” could be selected; alternatively it is also possible to select the pattern element “0”.

As for the step e), it is also possible that the step e) also comprises repeating the step a) in addition to repeating steps b) though e). This embodiment of the method thus preferably comprises a continuous calculation of the pulse firing pattern, and the target parameter can be supplied to e.g. the control unit 13 in any moment, such that the continuous calculation allows to have a pulse firing pattern allowing a power transfer to the collecting electrodes and discharge electrodes 19 always moving towards the target parameter.

The continuous repetition can be implemented by defining a pattern period or pulse firing pattern length and calculating the first parameter and the second parameter on the basis of the pattern period or pulse firing pattern length.

For example, a start and an end can be defined in the pulse firing pattern; the start correspond to the element added first to the pulse firing pattern and the end to the element added last to the pulse firing pattern, i.e. the additional elements are added to the end of the pulse firing pattern.

Thus, calculating the first parameter and the second parameter on the basis of the pattern period can comprise:

calculating the first parameter indicative of the power supplied to the electrostatic precipitator using a pulse firing pattern having

the pulse period or pulse firing pattern length, and

one additional first element, and

deprived of one element at the start;

calculating a second parameter indicative of the power supplied to the electrostatic precipitator using a pulse firing pattern having

the pulse period, and

two additional second elements, and

deprived of two elements at the start.

Naturally continuous calculation (implementing by the feature e) above) can also be implemented without repeating the step a).

As an alternative, it is also possible discontinuation of the Step e) can be achieved when the first parameter or second parameter becomes equal to the target parameter or when the first parameter and second parameter depart from the target parameter. In this case once one or more pulse firing patterns are calculated, they can be implemented in the electrostatic precipitator, for example different pulse firing patterns can be defined for different flue gas features and power required at the collecting electrodes and discharge electrodes 19.

The control unit 13 implements the pulsed firing pattern 20 and preferably has a computer readable memory medium containing instructions to implement the method.

Naturally the features described may be independently provided from one another.

What is claimed is:

1. An electrostatic precipitator comprising:
a power input operative to provide electrical power;
a filter in electronic communication with the power input;
a controller operative to pulse the electrical power via the filter based at least in part on a pulse firing pattern; and
one or more collecting electrodes and one or more discharge electrodes each operative to receive the pulsed electrical power;
wherein the pulse firing pattern includes:
at least two first elements indicative of the electrical power being pulsed on; and
a plurality of second elements indicative of the electrical power not being pulsed on.

2. The electrostatic precipitator of claim 1, wherein the pulse firing pattern further includes at least 1,000 elements between the at least two first elements and the plurality of second elements.

3. The electrostatic precipitator of claim 1, wherein the pulse firing pattern further includes at least 10,000 elements between the at least two first elements and the plurality of second elements.

4. The electrostatic precipitator of claim 1, wherein the pulse firing pattern further includes at least 20 elements between the at least two first elements and the plurality of second elements.

5. The electrostatic precipitator of claim 1, wherein the controller is further operative to generate the pulse firing pattern based at least in part on a desired value of the pulsed electrical power at the one or more collecting and the one or more discharge electrodes.

6. The electrostatic precipitator of claim 1 further comprising:
a transformer operative to transform the pulsed electrical power prior to being received by the one or more collecting electrodes and the one or more discharge electrodes.

7. The electrostatic precipitator of claim 1 further comprising:
a rectifier operative to rectify the pulsed electrical power prior to being received by the one or more collecting electrodes and the one or more discharge electrodes.

8. The electrostatic precipitator of claim 1, wherein the one or more collecting electrodes and the one or more discharge electrodes are disposed in the path of a flue gas and are further operative to clean the flue gas based at least in part on the received pulsed electrical power.

9. A method of cleaning a flu gas via an electrostatic precipitator having one or more collecting and discharge electrodes disposed in the path of a flue gas, the method comprising:
pulsing electrical power via a controller in electronic communication with a filter disposed between a power input, that provides the electrical power, and the one or more collecting and discharge electrodes; and
receiving the pulsed electrical power at the one or more collecting and discharge electrodes;
wherein the controller pulses the electrical power based at least in part on a pulsed firing pattern that includes:
at least two first elements indicative of the electrical power being pulsed on; and
a plurality of second elements indicative of the electrical power not being pulsed on.

10. The method of claim 9, wherein the pulse firing pattern further includes at least 1,000 elements between the at least two first elements and the plurality of second elements.

11. The method of claim 9, wherein pulse firing pattern further includes at least 10,000 elements between the at least two first elements and the plurality of second elements.

12. The method of claim 9, wherein pulse firing pattern further includes at least 20 elements between the at least two first elements and the plurality of second elements.

13. The method of claim 9 further comprising:
generating the pulse firing pattern based at least in part on a desired value of the pulsed electrical power at the one or more collecting and discharge electrodes.

14. The method of claim 9 further comprising:
transforming the pulsed electrical power via a transformer prior to being received by the one or more collecting and discharge electrodes.

15. The method of claim 9 further comprising:
rectifying the pulsed electrical power via a rectifier prior to being received by the one or more collecting and discharge electrodes.

16. A non-transitory computer readable medium comprising instructions that adapt a controller to:
pulse electrical power via a filter based at least in part on a pulse firing pattern, the electrical power provided by a power input and received by one or more collecting and discharge electrodes each disposed in the path of a flue gas, the filter disposed between the power input and the one or more collecting and discharge electrodes;
wherein the pulse firing pattern includes:
at least two first elements indicative of the electrical power being pulsed on; and
a plurality of second elements indicative of the electrical power not being pulsed on.

17. The non-transitory computer readable medium of claim 16, wherein
the pulse firing pattern further includes at least 1,000 elements between the at least two first elements and the plurality of second elements.

18. The non-transitory computer readable medium of claim 16, wherein
the pulse firing pattern further includes at least 10,000 elements between the at least two first elements and the plurality of second elements.

19. The non-transitory computer readable medium of claim 16, wherein
the pulse firing pattern further includes at least 20 elements between the at least two first elements and the plurality of second elements.

20. The non-transitory computer readable medium of claim 16, wherein the stored instructions further adapt the controller to:
define the pulse firing pattern based at least in part on a desired value of the pulsed electrical power at the one or more collecting and discharge electrodes.
